(19) United States
(12) Patent Application Publication
(10) Pub. No.: US 2010/0025295 A1
(43) Pub. Date: Feb. 4, 2010

(54) Process for Separating Solids from Gas

(76) Inventor: Robert L. Mehlberg, Wheaton, IL (US)

Correspondence Address: HONEYWELL/UOP;PATENT SERVICES, 101 COLUMBIA DRIVE, P O BOX 2245 MAIL STOP AB/2B, MORRISTOWN, NJ, 07962, US

(21) Appl. No.: 12/182,162

(22) Filed: Jul. 30, 2008

(51) Int. Cl. C10G 11/00; B01D 53/24

(52) U.S. Cl. 208/113; 95/35

(57) ABSTRACT

A process separates solids from gas in a vessel using cyclones. The cyclones have centers located at different distances from a center of the vessel, but the inlets to the cyclones are located at the same distance from the center to balance the proportions of catalyst fines entering each cyclone.

### BACKGROUND OF THE INVENTION

The invention relates to an apparatus and process for separating particulate solids from gas. This invention specifically relates to separation of particulate catalyst from product or combustion gases in the field of fluid catalytic cracking (FCC).

FCC is a hydrocarbon conversion process accomplished by contacting hydrocarbons in a fluidized reaction zone with a catalyst composed of finely divided particulate material. The reaction in catalytic cracking, as opposed to hydrocracking, is carried out in the absence of substantial added hydrogen or the consumption of hydrogen. As the cracking reaction proceeds substantial amounts of highly carbonaceous material referred to as coke are deposited on the catalyst. Vaporous products are separated from spent catalyst in a reactor vessel. Spent catalyst may be subjected to stripping over an inert gas such as steam to strip entrained hydrocarbonaceous gases from the spent catalyst. A high temperature regeneration with oxygen within a regeneration zone operation burns coke from the stripped catalyst. Fluidization of the catalyst particles by various gaseous streams allows the transport of catalyst between the reaction zone and regeneration zone.

Efficient separation of particulate catalyst from product vapors and combustion gases is very important in an FCC process. Particulate catalyst that is not effectively separated from gaseous fluids in the FCC unit must be separated downstream either by filtration methods or additional separation devices that multiply separation devices utilized in the FCC unit. Additionally, catalyst that is not recovered from the FCC process represents a two-fold loss. The catalyst must be replaced, representing a material cost, and catalyst lost may cause erosion to downstream equipment. Severe erosion may cause equipment failure and subsequent lost production time. Accordingly, methods of efficiently separating particulate catalyst materials from gaseous fluids in an FCC process are of great utility. Cyclonic methods for the separation of solids from gases are well known and commonly used.

In the FCC process, gaseous fluids are partially separated from particulate catalyst solids as they are discharged from a conduit. One such separation is typically conducted in what is called a reactor vessel. The reactor vessel typically has an inlet for the entry of spent catalyst and gaseous cracked products through or from a riser reactor, an upper exit for product gaseous cracked products and a lower exit for spent catalyst. Another separation of gases from solids in an FCC unit is conducted in the regenerator. Conventional regenerators typically comprise a vessel having a spent catalyst inlet, a regenerated catalyst outlet and a distributor for supplying air to the bed of catalyst that resides in the vessel. In two-stage regenerators, a riser transports catalyst and combustion gases, perhaps from a lower chamber, into a chamber in which the catalyst may undergo further generation. A partial separator may separate catalyst from combustion gases as they enter the regenerator vessel or chamber thereof. However, additional separation of entrained catalyst solids from gases is necessary in both the reactor vessel and the regeneration vessel.

The most common method of separating particulate solids from a gas stream uses centripetal separation. Centripetal separators are well known and operate by imparting a tangential velocity to gases containing entrained solid particles that forces the heavier solids particles outwardly away from the lighter gases for upward withdrawal of gases and downward collection of solids. Cyclones for separating particulate material from gaseous materials are well known to those skilled in the art of FCC processing. Cyclones usually comprise an inlet duct that is tangential to the outside of a cylindrical barrel that forms an outer wall of the cyclone. In the operation of the cyclone, the inlet duct and the inner surface of the barrel cooperate to create a spiral flow path of the gaseous materials and catalyst that establishes a vortex in the cyclone. The centripetal acceleration associated with an exterior of the vortex causes catalyst particles to migrate towards the outside of the barrel while the gaseous materials enter an interior of the vortex for eventual discharge through an upper gas outlet. The gas outlet may extend down into the barrel, so that gases have to travel downwardly then upwardly to exit the cyclone. The heavier catalyst particles entrained in the gases in large proportion continue downwardly while the gases change direction upwardly. These and other heavier catalyst particles swirling around the sidewall of the cyclone barrel after losing angular momentum eventually drop to the bottom of the cyclone. The catalyst particles then exit the cyclone via a dipleg outlet conduit for recycle through the FCC apparatus. Cyclone arrangements and modifications thereto are generally disclosed in U.S. Pat. No. 4,670,410 and U.S. Pat. No. 2,535,140. Cyclones are often arranged in pairs. A primary cyclone receives a mixture of gas and catalyst from the vessel and sends partially purified gas through the gas outlet to a secondary cyclone for further separation.

As greater demands are placed on FCC units, regenerator and reactor vessels are being required to handle greater catalyst throughput. Greater quantities of combustion gas are added to the regenerator vessels to combust greater quantities of catalyst. The same increases are being experienced in reactor vessels with greater quantities of product gases and catalyst. Additionally, more cyclones are needed in these vessels to separate entrained catalyst from gases in the vessels. Cyclones may be assembled in a staggered arrangement to fit more cyclones in the vessel.

Because cyclones process large quantities of mixtures of small solids and gas, the interior of the metal cyclones are subjected to erosion which can damage the cyclone. Refractory is conventionally installed on the interior surface of the cyclones and the vessel containing the cyclones to mitigate the erosive effect. Other ways of mitigating erosion and loss of catalyst are sought in the art.

### SUMMARY OF THE INVENTION

We have found that as regenerator vessels are getting larger and throughput is increased in the catalyst regenerator, cyclones in a staggered arrangement located closer to the center of the vessel are taking in disproportionately larger quantities of catalyst fines. The disproportionately larger quantity of smaller catalyst particles is eroding the interior of the cyclones and being carried off with exiting gases. We have found that by locating the cyclone inlets of staggered cyclones at the same distance from the center of the vessel, the intake of catalyst fines becomes more balanced between inner and outer cyclones.

### BRIEF DESCRIPTION OF THE DRAWINGS

FIG. 1 is a schematic, elevational view of an FCC unit incorporating the present invention.

FIG. 2 is a plan view of the vessel of the present invention.

FIG. 3 is a plan view of an alternative vessel of the present invention.

### DETAILED DESCRIPTION OF THE INVENTION

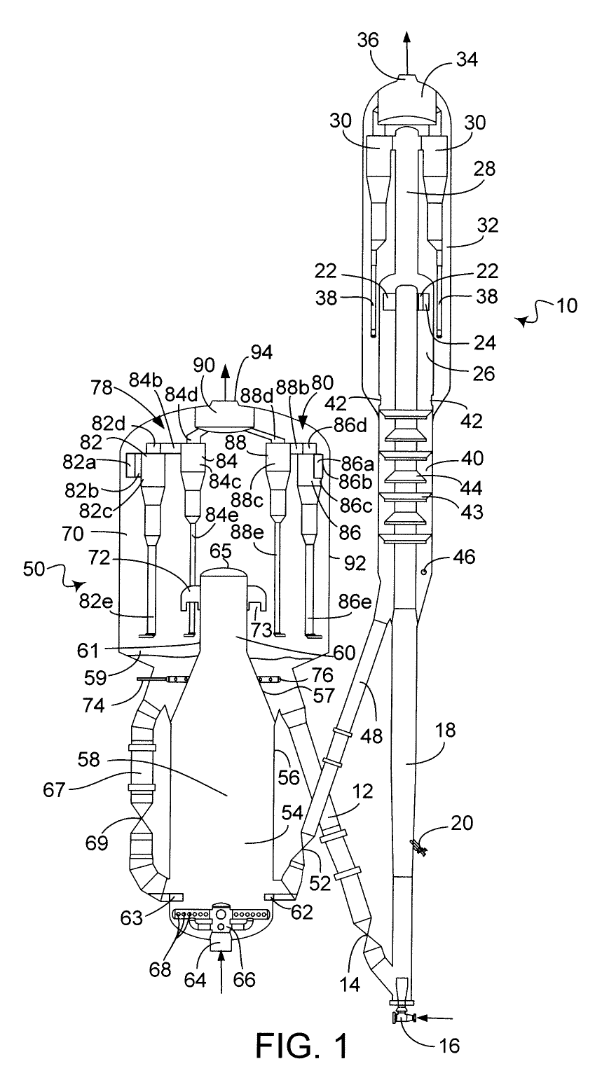

Although the process and apparatus of the present invention may be useful in any solids-gas separation equipment, it finds ready usefulness in an FCC unit. FIG. 1 shows an FCC unit that includes a reactor vessel 10 and a regenerator vessel 50. A regenerator standpipe 12 transfers catalyst from the regenerator vessel 50 at a rate regulated by a slide valve 14 to a reactor riser 18. A fluidization medium such as steam from a nozzle 16 transports catalyst upwardly through the riser 18 at a relatively high density until a plurality of feed injection nozzles 20 (only one is shown) inject feed across the flowing stream of catalyst particles.

A conventional FCC feedstock or higher boiling hydrocarbon feedstock are suitable feeds. The most common of such conventional feedstocks is a “vacuum gas oil” (VGO), which is typically a hydrocarbon material having a boiling range of from 343 to 552° C. (650 to 1025° F.) prepared by vacuum fractionation of atmospheric residue. Such a fraction is generally low in coke precursors and heavy metal contamination which can serve to contaminate catalyst. Heavy hydrocarbon feedstocks to which this invention may be applied include heavy bottoms from crude oil, heavy bitumen crude oil, shale oil, tar sand extract, deasphalted residue, products from coal liquefaction, atmospheric and vacuum reduced crudes. Heavy feedstocks for this invention also include mixtures of the above hydrocarbons and the foregoing list is not comprehensive.

The resulting mixture continues upwardly through the riser 18 to a top at which a pair of disengaging arms 22 tangentially and horizontally discharge the mixture of gas and catalyst from a top of the riser 18 through ports 24 (only one is shown) into a disengaging vessel 26 that effects partial separation of gases from the catalyst. A transport conduit 28 carries the hydrocarbon vapors, including stripped hydrocarbons, stripping media and entrained catalyst to one or more cyclones 30 in the reactor vessel 10 which separates spent catalyst from the hydrocarbon vapor stream. Although the present invention can be utilized in the reactor vessel 10, it is not illustrated in the reactor vessel but in the regenerator vessel 50. A collection chamber 34 in the reactor vessel 10 gathers the separated hydrocarbon vapor streams from the cyclones 30 for passage to an outlet nozzle 36 and eventually into a fractionation recovery zone (not shown). Diplegs 38 discharge catalyst from the cyclones 30 into a lower portion of the reactor vessel 10 that eventually passes the catalyst and adsorbed or entrained hydrocarbons into a stripping section 40 across ports 42 defined in a wall of the disengaging vessel 26. Catalyst separated in the disengaging vessel 26 passes directly into the stripping section 40. The stripping section 40 contains baffles 43, 44 or other equipment to promote mixing between a stripping gas and the catalyst. The stripping gas enters a lower portion of the stripping section 40 through at least one outlet 46 to one or more distributors (not shown). The spent catalyst leaves the stripping section 40 through a spent catalyst conduit 48 and passes into the regenerator vessel 50 at a rate regulated by a slide valve 52.

The riser 18 of the FCC process is maintained at high temperature conditions which generally include a temperature above about 425° C. (797° F.). In an embodiment, the reaction zone is maintained at cracking conditions which include a temperature of from about 480° to about 590° C. (896° to 1094° F.) and a pressure of from about 69 to about 517 kPa (ga) (10 to 75 psig) but typically less than about 275 kPa (ga) (40 psig). The catalyst-to-oil ratio, based on the weight of catalyst and feed hydrocarbons entering the bottom of the riser, may range up to 20:1 but is typically between about 4:1 and about 10:1. Hydrogen is not normally added to the riser, although hydrogen addition is known in the art. Steam may be passed into the riser 18 and reactor vessel 10 equivalent to about 4-7 wt-% of feed. The average residence time of catalyst in the riser may be less than about 5 seconds. The type of catalyst employed in the process may be chosen from a variety of commercially available catalysts. A catalyst comprising a zeolite base material is preferred, but the older style amorphous catalyst can be used if desired.

The regenerator vessel 50 may be a combustor type of regenerator, which may use hybrid turbulent bed-fast fluidized conditions in a high-efficiency regenerator vessel 50 for completely regenerating spent catalyst. However, other regenerator vessels and other flow conditions may be suitable for the present invention. The spent catalyst conduit 48 feeds spent catalyst to a first or lower chamber 54 defined by outer wall 56 through a spent catalyst inlet chute 62. The spent catalyst from the reactor vessel 10 usually contains carbon in an amount of from 0.2 to 2 wt-%, which is present in the form of coke. Although coke is primarily composed of carbon, it may contain from 3 to 12 wt-% hydrogen as well as sulfur and other materials. An oxygen-containing combustion gas, typically air, enters the first chamber 54 of the regenerator vessel 50 through a conduit 64 and is distributed by a distributor 66. Openings 68 in the distributor 66 emit combustion gas. As the combustion gas enters a combustion section 58, it contacts spent catalyst entering from chute 62 and lifts the catalyst at a superficial velocity of combustion gas in the first chamber 54 of at least 1.1 m/s (3.5 ft/s) under fast fluidized flow conditions. In an embodiment, the combustion section 58 will have a catalyst density of from 48 to 320 kg/m³ (3 to 20 lb/ft³) and a superficial gas velocity of 1.1 to 2.2 m/s (3.5 to 7 ft/s). The oxygen in the combustion gas contacts the spent catalyst and combusts carbonaceous deposits from the catalyst to at least partially regenerate the catalyst and generate flue gas.

In an embodiment, to accelerate combustion of the coke in the first chamber 54, hot regenerated catalyst from a dense catalyst bed 59 in an upper or second chamber 70 may be recirculated into the first chamber 54 via an external recycle standpipe 67 regulated by a control valve 69. Hot regenerated catalyst enters the regenerator chamber 54 through an inlet chute 63. Recirculation of regenerated catalyst, by mixing hot catalyst from the dense catalyst bed 59 with relatively cold spent catalyst from the reactor conduit 48 entering the first chamber 54, raises the overall temperature of the catalyst and gas mixture in the first chamber 54.

The mixture of catalyst and combustion gas in the first chamber 54 ascend from the combustion section 58 through a frustoconical transition section 57 to the transport, riser section 60 of the first chamber 54. The riser section is defined by an outer wall 61 to define a tube which is preferably cylindrical and extends preferably upwardly from the combustion chamber 54. The mixture of catalyst and gas travels at a higher superficial gas velocity than in the combustion section 58. The increased gas velocity is due to the reduced cross-sectional area of the riser section 60 relative to the cross-sectional area of the lower chamber 54 below the transition section 57. Hence, the superficial gas velocity will usually exceed about 2.2 m/s (7 ft/s). The riser section 60 will have a lower catalyst density of less than about 80 kg/m³ (5 lb/ft³).

The regenerator vessel 50 also includes an upper or second chamber 70. The mixture of catalyst particles and flue gas is discharged from an upper portion of the riser section 60 into the upper chamber 70. Substantially completely regenerated catalyst may exit the top of the transport, riser section 60, but arrangements in which partially regenerated catalyst exits from the first chamber 54 are also contemplated. Discharge is effected through a disengaging device 72 that separates a majority of the regenerated catalyst from the flue gas. In an embodiment, catalyst and gas flowing up the riser section 60 impact a top elliptical cap 65 of the riser section 60 and reverse flow. The catalyst and gas then exit through downwardly directed discharge inlets 73 of disengaging device 72. The sudden loss of momentum and downward flow reversal cause a majority of the heavier catalyst to fall to the dense catalyst bed 59 and the lighter flue gas and a minor portion of the catalyst still entrained therein to ascend upwardly in the second chamber 70. Downwardly falling disengaged catalyst collects in the dense catalyst bed 59. Catalyst densities in the dense catalyst bed 59 are typically kept within a range of from about 640 to about 960 kg/m³ (40 to 60 lb/ft³). A fluidizing conduit 74 delivers fluidizing gas, typically air, to the dense catalyst bed 59 through a fluidizing distributor 76. In a combustor-style regenerator, approximately no more than 2% of the total gas requirements within the process enters the dense catalyst bed 59 through the fluidizing distributor 76. In this embodiment, gas is added here not for combustion purposes but only for fluidizing purposes, so the catalyst will fluidly exit through the standpipes 67 and 12. The fluidizing gas added through the fluidizing distributor 76 may be combustion gas. In the case where partial combustion is effected in the first chamber 54, greater amounts of combustion gas will be fed to the second chamber 70 through conduit 74.

For simplicity, FIG. 1 shows cyclones 82 and 86 disposed at offset radial positions. The cyclones 82, 86 are disposed at the same vertical position, but this is not necessary. Inner cyclone 82 is disposed closer to a center of the vessel 50; whereas, outer cyclone 86 is disposed further from the center of the vessel 50. Cyclones 82 and 86 are equipped with inlets 82a and 86a for receiving a mixture of flue gas and entrained particles of catalyst. Inlet ducts 82b and 86b transport the mixture of gas and catalyst particles to the cyclone barrel 82c and 86c. The inlet duct 82b and 86b provides a passage which communicates and tangentially distributes the mixture of gas and catalyst particles into the cylindrical cyclone barrel 82c, 86c directing the mixture to swirl such that the denser catalyst gravitates toward the outside of the barrel and the lighter gases gravitate toward the inside of the barrel. The swirling effects a primary centripetal separation of catalyst from the gas. Flue gas, with a lighter load of catalyst than before entering the cyclone 82, 86 and in the upper chamber 70 of the regenerator vessel 50, is emitted from the cyclone 82 and 86 through a gas outlet 82d, 86d in communication with the barrel 82c, 86c. Separated catalyst is dispensed from the cyclone through diplegs 82e, 86e in communication with the barrel 82c, 86c into a dense bed 59 in a bottom of the upper chamber 70 in said regenerator vessel 50. In an aspect, flue gas from gas outlets 82d, 86d may be delivered to a plenum 90 from which it exits the regenerator vessel 50. In an aspect, the cyclones 82, 84 may include one or more frustoconical hoppers between the barrel and the dipleg and include a flapper valve at the bottom of the dipleg to prevent back flow into the dipleg.

FIG. 1 shows an aspect of the invention in which cyclone pairs 78 and 80 disposed at offset radial positions contain primary cyclones 82 and 86 and secondary cyclones 84 and 88, respectively. The pairs 78, 80 are disposed at the same vertical position, but this is not necessary. It is also not necessary to assemble the cyclones in pairs, but may be done to further separate gas from solids. Inner cyclone pair 78 is disposed closer to a center of the vessel 50; whereas, outer cyclone pair 80 is disposed further from the center of the vessel 50. Partially purified flue gas with a lighter loading of catalyst particles than the flue gas in the upper chamber 70 travels from gas outlets 82d and 86d through inlet ducts 84b, 88b and enters secondary cyclones 84 and 88. The gas outlets 82d, 86d communicate with inlet ducts 84b, 88b. The latter communicate and tangentially distribute the mixture of gas and catalyst particles into the cylindrical cyclone barrel 84c, 88c, directing the mixture to swirl such that the denser catalyst gravitates toward the outside of the barrel and the lighter gases gravitate toward the inside of the barrel. The swirling effects a primary centripetal separation of catalyst from the gas. Flue gas, with a lighter load of catalyst than before entering the secondary cyclone 84, 88 and in the upper chamber 70 of the regenerator vessel 50, is emitted from the secondary cyclone 84 and 88 through a gas outlet 84d, 88d in communication with the barrel 84c, 88c. Separated catalyst is dispensed from the cyclone through diplegs 84e, 88e in communication with the barrel 84c, 88c into a dense bed 59 in a bottom of the upper chamber 70 in said regenerator vessel 50. In an aspect, flue gas from gas outlets 84d, 88d may be delivered to a plenum 90 from which it exits the regenerator vessel 50. In an aspect, the secondary cyclones 84, 88 may include one or more frustoconical hoppers between the barrel and the dipleg and include a flapper valve at the bottom of the dipleg to prevent back flow into the dipleg. Separated flue gas is withdrawn from the regenerator vessel 50 through an exit conduit 94.

From about 10 to 30 wt-% of the catalyst discharged from the regenerator chamber 54 is present in the gases above the exit from the riser section 60 and enter the cyclone separators 98, 99. Catalyst from the dense catalyst bed 59 is transferred through the regenerator standpipe 12 back to the reactor vessel 10 where it again contacts feed as the FCC process continues. The regenerator vessel of the present invention may typically require 14 kg of air per kg of coke removed to obtain complete regeneration. When more catalyst is regenerated, greater amounts of feed may be processed in a conventional reaction vessel. The regenerator vessel 50 typically has a temperature of about 594 to about 704° C. (1100 to 1300° F.) in the first chamber 54 and about 649 to about 760° C. (1200 to 1400° F.) in the second chamber 100.

We have found that cyclones with inlets closer to the center of the vessel and further from the wall take in a greater proportion of fine catalyst particles than cyclones with inlets further from the center of the vessel and closer to the wall. We have discovered that arranging the inlets 82a, 86a of staggered inner and outer primary cyclones 82, 86 at the same distance from the center of the vessel and at the same distance from the wall of the vessel 50, if the vessel is cylindrical, the inner and outer primary cyclones receive an equivalent proportion of catalyst fines; i.e., within about 10 wt-%. The outer primary cyclone 86 is shown in FIG. 1 to be further from a center of upper chamber 72 of the regenerator vessel 50 and closer to an outer wall 92 of the upper chamber 70 of the regenerator vessel 50 than inner primary cyclone 82. The inner primary cyclone 82 is shown in FIG. 1 to be closer to the center of the upper chamber of the regenerator vessel 50 and further from the outer wall of the upper chamber of the regenerator vessel 50. However, the inlets to the primary cyclones 82 and 86 are substantially the same distance from the center and the outer wall 92 of the upper chamber.

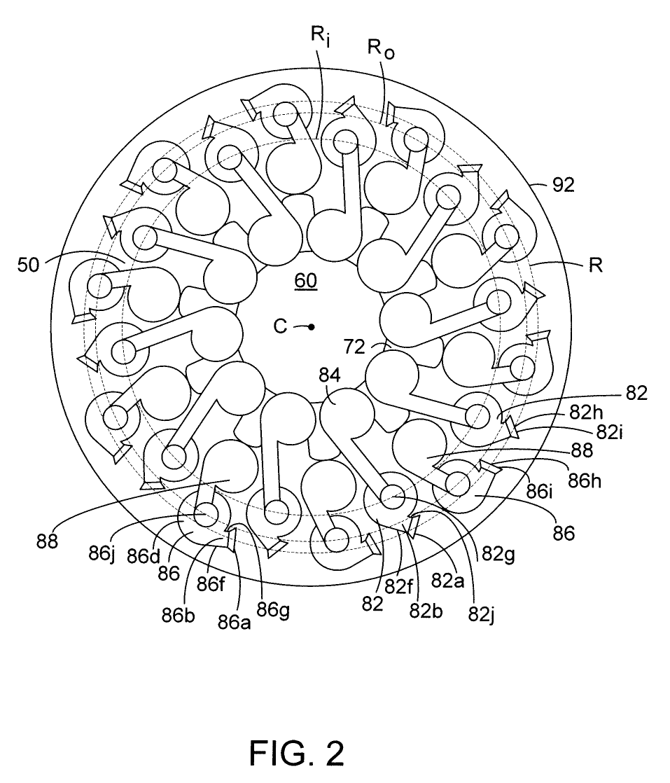

FIG. 2 is a plan view of upper chamber 70 of the regenerator vessel 50. The inlets 82a, 86a of cyclones 82, 86 may be defined by the inlet duct 82b, 86b having two vertical sides 82f, 82g and 86f, 86g. The inlet ducts 82b and 86b of the outer cyclones 82, 86 may be flared out to catch particulates. An inlet center 82h, 86h is provided at the middle of imaginary line 82i, 86i connecting the outer edges of both sides 82f, 82g and 86f, 86g. Inlet centers 82h and 86h are substantially located at the same distance from the center C of the upper chamber 70 of the regenerator vessel 50 as shown by circle with radius R. In another aspect, the inlets 82a, 86a defined by the inlet duct 82b, 86b may have an outer edge or edges that define a plane (not shown), and the inlet center 82h, 86h would be located at a center of the plane. FIG. 2 shows that barrels 82d, 86d are generally cylindrical. The centers of the cyclones are the barrel centers 82j, 86j located in the middle of the circle defined by a top-most cross-section of the barrels 82d, 86d. The barrel centers 82j, 86j are located at substantially different distances from the center C of the vessel 50. Barrel centers 86j are located at a greater distance from the center C as shown by outer radius Rₒ that barrel centers 82j shown by inner radius Rᵢ. In the embodiment of FIG. 2 the inner and outer cyclones 82, 86 are oriented differently, so their inlets 82a, 86a have inlet centers 82h, 86h located at the same distance from the center C of the vessel on radius R. However, the cyclones 82, 86 are still arranged in a staggered manner for greater cyclone density in the regenerator vessel 50 around riser 60 and disengaging device 72. The inner cyclones 82 are rotated clockwise such that inlet ducts 82b direct the inlet 82a toward the wall 92. The outer cyclones 86 are rotated counter clockwise such that inlet ducts 86b direct the inlet 86a away from the wall 92 and more toward the center C of the vessel 50. Cyclones 82 and 86 are in communication with secondary cyclones 84 and 88, respectively, for further separation of gas from catalyst.

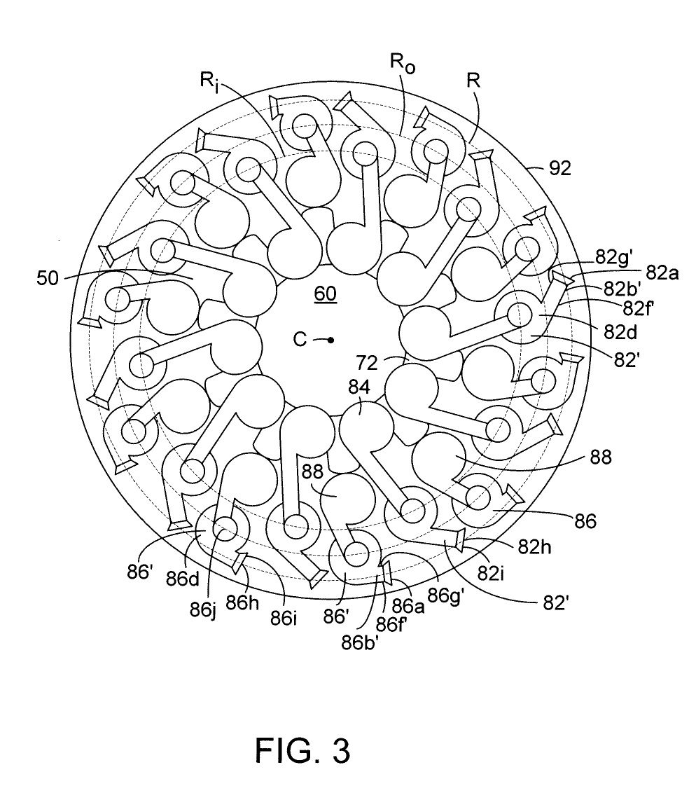

FIG. 3 is a plan view of upper chamber 70 of the regenerator vessel 50 in an alternative embodiment. Elements in FIG. 3 of the same configuration in FIG. 2 will be designated with the same reference numerals. Elements corresponding to the elements of FIG. 2 but with different configurations will be designated with a prime (“′”) symbol. The inlets 82a, 86a of cyclones 82′, 86′ may be defined by the inlet duct 82b′, 86b′ having two vertical sides 82f′, 82g′ and 86f′, 86g′ which have been elongated relative to those elements in FIG. 2. An inlet center 82h, 86h is provided at the middle of imaginary line 82i, 86i connecting the outer edges of both sides 82f′, 82g′ and 86f′, 86g′. Inlet centers 82h and 86h are substantially located at the same distance from the center C of the upper chamber 70 of the regenerator vessel 50 as shown by circle with radius R. In another aspect, the inlets 82a, 86a defined by the inlet duct 82b′, 86b′ may have an outer edge or edges that define a plane (not shown), and the inlet center 82h, 86h would be located at a center of the plane. FIG. 3 shows that barrels 82d, 86d are generally cylindrical. The centers of the cyclones are the barrel centers 82j, 86j located in the middle of the circle defined by a top-most cross-section of the barrels 82d, 86d. The barrel centers 82j, 86j are located at substantially different distances from the center C of the vessel 50 and from the wall 92. Barrel centers 86j are located at a greater distance from the center C as shown by outer radius Rₒ than barrel centers 82j shown by inner radius Rᵢ. In the embodiment of FIG. 3 the elongated inlet ducts 82b′ of inner cyclones 82′ extend the inlets 82a to the same distance as the distance of the inlets 86a of outer cyclones 86′, so their inlets 82a, 86a have inlet centers 82h, 86h located at the same distance from the center C of the vessel on radius R. Inlet ducts 82b′ have greater lengths than inlet ducts 86b′. However, the cyclones 82, 86 are still arranged in a staggered manner for greater cyclone density in the regenerator vessel 50 around riser 60 and disengaging device 72. Cyclones 82 and 86 are in communication with secondary cyclones 84 and 88, respectively.

The term “substantially” as applied to distances from the center of the vessel is equal to 5% of the radius from center.

### EXAMPLE

Modeling was performed to determine the proportion of fines entering cyclones in a staggered relationship. Fines were defined as solid particles with diameters of 48 microns and smaller. A base case was evaluated for cyclones with inlets at different distances from the center of a vessel. To the base case was compared the proportion of fines entering cyclones with centers at different distances from the center of the vessel but with inlets at the same distance from the center of the vessel. Results are shown in the following table.

| | | Inner | Outer |
|---|---|---|---|
| Case | Bed | Cyclone | Cyclone |
| Base | 38 | 35 | 27 |
| Inlets on same radius | 42 | 30 | 28 |

The above table shows that in both cases that around 40 wt-% of the catalyst particles of 48 microns were captured in the bed at the bottom of the vessel. In the base case about 30 wt-% more catalyst particles entered into the inner cyclones than the outer cyclones. The disproportionate amount of catalyst fines in the inner cyclones can subject them to additional erosion. However, in the case in which the inlets are on the same radius only about 7 wt-% more catalyst fines enters the inner cyclones. The present invention balances the fines entry significantly between inner and outer cyclones, such that substantially equivalent amounts of fines enter both cyclones.

1. A process for separating particulate solids from a gas, said process comprising:
discharging a stream of gas into said vessel;
discharging a stream of particulate solids into said vessel;
passing a stream of gas carrying particulate solids into a respective inlet of at least two cyclones in said vessel, said inlet center of said inlet of said two cyclones being located at substantially the same distance from the center of said vessel;
directing said gas carrying solids to swirl in a barrel in communication with said inlet to effect a centripetal separation of the particulate solids from said gas in said cyclone, a barrel center of said barrel of said two cyclones being located at substantially different distances from a vessel center of said vessel;
emitting separated gas through a gas outlet in communication with said barrel from said cyclone; and
dispensing separated solids through a dipleg in communication with said barrel from said cyclone into a bottom of said vessel.

2. The process of claim 1 further comprising passing an equivalent proportion of solid fines through respective inlets of both cyclones.

3. The process of claim 1 further comprising separating gas emitted from said gas outlet with a lighter loading of solids from said solids in a secondary cyclone.

4. The process of claim 1 wherein the barrel is a cylinder and the barrel center is circular middle of a top cross section of said cylinder.

5. The process of claim 1 further including discharging said gas into said vessel through an opening in an appendage to a riser that terminates in the center of said vessel and effecting a partial separation of particulate solids from gas.

6. The process of claim 1 wherein said two cyclones are oriented differently.

7. The process of claim 3 wherein said two cyclones have inlet ducts of different lengths.

8. A process for separating particulate solids from a gas, said process comprising:
discharging a stream of gas into said vessel;
discharging a stream of particulate solids into said vessel;
passing a stream of gas with a substantially equivalent flow rate of solid fines through a respective inlet of at least two cyclones;
directing said gas carrying solids to swirl in a barrel in communication with said inlet to effect a centripetal separation of the particulate solids from said gas in said cyclone, a barrel center of said barrel of said two cyclones being located at substantially different distances from a vessel center of said vessel;
emitting separated gas through a gas outlet in communication with said barrel from said cyclone; and
dispensing separated solids through a dipleg in communication with said barrel from said cyclone into a bottom of said vessel.

9. The process of claim 8 wherein said inlet centers of said inlet of said two cyclones are located at substantially the same distance from the center of said vessel.

10. The process of claim 8 wherein the inlet is defined by a duct having an outer edge and the inlet center is located at a center of an imaginary plane defined by the outer edge.

11. The process of claim 8 wherein the barrel is a cylinder and the barrel center is circular middle of a top cross section of said cylinder.

12. The process of claim 8 further including discharging said gas into said vessel through an opening in an appendage in a riser that terminates in the center of said vessel and effecting a partial separation of particulate solids from gas.

13. The process of claim 8 wherein said two cyclones are oriented differently.

14. The process of claim 10 wherein said two cyclones have ducts of different lengths.

15. A process for fluid catalytically cracking hydrocarbons, said process comprising:
contacting a hydrocarbon feed with a regenerated catalyst;
catalytically cracking said hydrocarbons to provide cracked hydrocarbons and spent catalyst;
separating said cracked hydrocarbons from said spent catalyst in a reactor vessel;
contacting said spent catalyst with oxygen to regenerate said spent catalyst in a regenerator vessel;
discharging a stream of gas into said regenerator vessel or said reactor vessel;
discharging a stream of catalyst into said regenerator vessel or said reactor vessel;
passing a stream of gas carrying catalyst into a respective inlet of at least two cyclones in said regenerator vessel or said reactor vessel, said inlet center of said inlet of said two cyclones being located at substantially the same distance from the center of said regenerator vessel or said reactor vessel;
directing said gas carrying catalyst to swirl in a barrel in communication with said inlet to effect a centripetal separation of the catalyst from said gas in said cyclone, a barrel center of said barrel of said two cyclones being located at substantially different distances from a vessel center of said regenerator vessel or said reactor vessel;
emitting separated gas through a gas outlet in communication with said barrel from said cyclone; and
dispensing separated catalyst through a dipleg in communication with said barrel from said cyclone into a bottom of said regenerator vessel or said reactor vessel.

16. The process of claim 15 further comprising passing a substantially equivalent proportions of catalyst fines through respective inlets of both cyclones.

17. The process of claim 15 wherein the inlet is defined by a duct having an outer edge and the inlet center is located at a center of an imaginary plane defined by the outer edge.

18. The process of claim 15 further including discharging said gas into said vessel through an opening in an appendage in a riser that terminates in the center of said regenerator vessel or said reactor vessel and effecting a partial separation of catalyst from gas.

19. The process of claim 15 wherein said two cyclones are oriented at differently.

20. The process of claim 17 wherein said two cyclones have ducts of different lengths.
